(19) United States
(12) Patent Application Publication
(10) Pub. No.: US 2005/0042938 A1
(43) Pub. Date: Feb. 24, 2005

(54) Electrical connector

(76) Inventors: Qisheng Zheng, Kunsan (CN); Shaoping Du, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/938,302

(22) Filed: Sep. 10, 2004

(30) Foreign Application Priority Data
Sep. 10, 2003 (TW) 92216347

(51) Int. Cl. H01R 13/24

(52) U.S. Cl. 439/824

(57) ABSTRACT

An electrical connector (100) includes an insulative housing (1), a pair of contact terminals (2) mounted on the housing, a pair of spring terminals (3) and a pair of retaining contacts (4). The insulative housing defines a receiving space for receiving the contact terminals and spring terminals through a top and bottom wall (10, 11) thereof. Each contact terminal includes a body portion (20), a cantilevered beam (21) and a contact portion (210) interconnecting top portions of body portion and cantilevered beam. The cantilevered beam downwardly and angularly extends from the contact portion. The cantilevered beam has a leading face (211) projecting beyond the top wall of the housing. Each spring terminal is retained between the contact terminal and the retaining contact. A mating electrical connector can upwardly slide along the leading face to electrically connect with the contact terminals by the leading surface.

### BACKGROUND OF THE INVENTION

1. Filed of the Invention

The present invention generally relates to an electrical connector and more particularly, to an electrical connector mounted on a printed circuit board.

2. Description of the Prior Art

Probe pin has been designed into connectors for the purpose of contacting with mating electrical connector, as is disclosed in U.S. Pat. No. 6,340,320 B1. In this patent, the probe pin vertically stands in an insulative housing and comprises a lower end standing in an upright sleeve enclosed by the insulative housing and an upper end upwardly exposed to outside of the housing. A coiled spring is assembled into the upright sleeve, with an upper end thereof supporting the lower end of the probe pin, and with a lower end thereof pressing a cover plate, which is located in a bottom portion of the sleeve, thereby providing the probe pin with flexibility. In use, a mating electrical connector (battery, memory card or printed circuit board etc.) presses the upper end of the vertically standing probe pin in a top-to-bottom direction, thereby electrically connecting with the conventional connector. However, said mating electrical connector only can downwardly press the probe pin, if a mating electrical connector is pushed to contact with side wall of the vertically standing probe pin in a side to side direction, the mating electrical connector is tend to be obstructed by the probe pin. Being pushed by such a large side face from the mating electrical connector, the probe pin tends to yield or fracture, resulting in a short life-span.

### SUMMARY OF THE INVENTION

An object, therefore, of the invention is to provide an improved electrical connector which is capable of conveniently contacting with a mating electrical connector in many directions, while having a relative long life-span.

In order to attain the above object, an electrical connector according to the present invention includes an insulative housing, a pair of contact terminals mounted on the housing, a pair of spring terminals and a pair of retaining contacts. The insulative housing defines a receiving space for receiving the contact terminals and spring terminals through a top and bottom wall thereof. Each contact terminal includes a body portion, a cantilevered beam and a contact portion interconnecting top portions of body portion and cantilevered beam. The cantilevered beam downwardly and angularly extends from the contact portion. The cantilevered beam has a leading face projecting beyond the top wall of the housing. Each spring terminal is retained between the contact terminal and the retaining contact. A mating electrical connector can upwardly slide along the leading face to electrically connect with the contact terminals by the leading surface.

Other objects, features and advantages of the invention will be apparent from the following detailed description taken in connection with the accompanying drawings.

### BRIEF DESCRIPTION OF THE DRAWINGS

The features of this invention are believed to be novel are set forth with particularly in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of an electrical connector according to the present invention;

FIG. 2 is another perspective view of the electrical connector;

FIG. 3 is an exploded view of FIG. 1; and

FIG. 4 is an exploded view of FIG. 2.

### DETAILED DESCRIPTION OF THE INVENTION

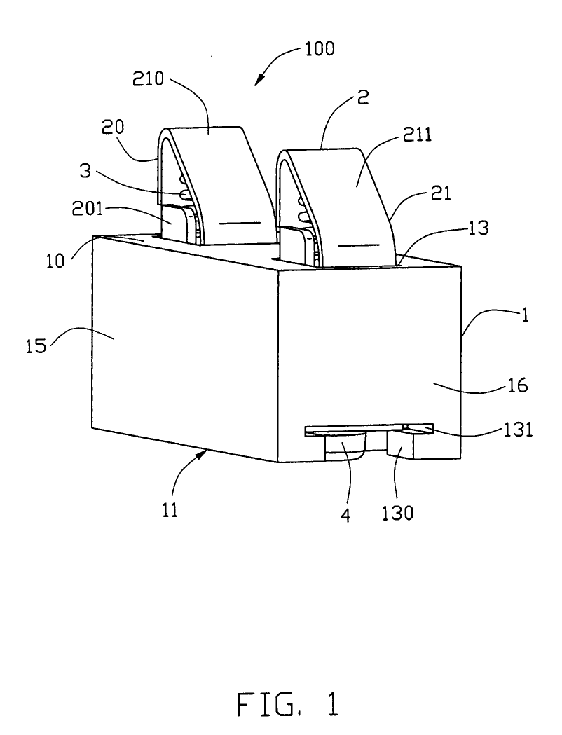

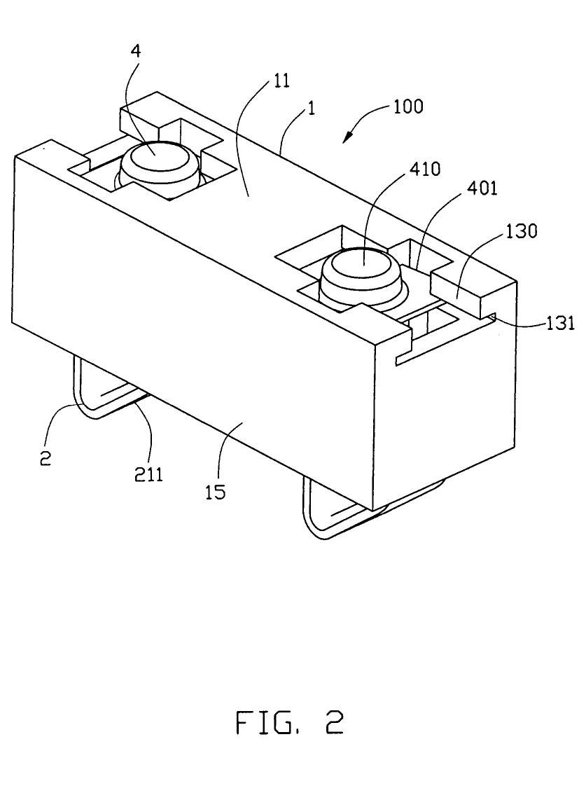

Referring to FIGS. 1-4, the present invention 100 includes an insulative housing 1, a pair of contact terminals 2 retained in the housing 1, a pair of spring terminals 3 and a pair of retaining contacts 4.

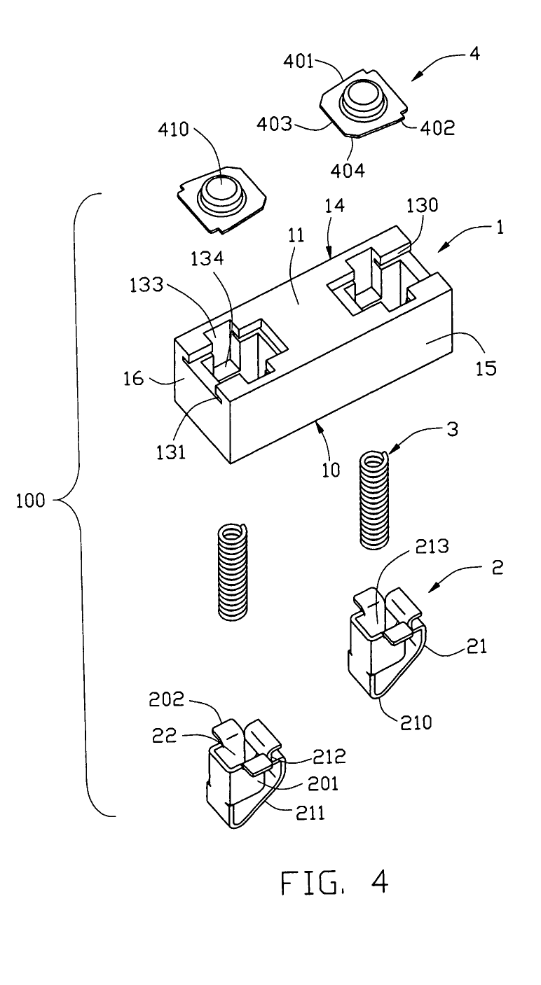

Referring to FIG. 4, the insulative housing 1 is substantially rectangular and includes a top wall 10, a bottom wall 11, a longitudinally extending front wall 14, an opposite rear wall 15 and opposite side walls 16. A pair of through holes (passageways) 13 is defined through the top and the bottom walls 10, 11 and is adjacent to corresponding side walls 16 of the housing 1. Two pairs of slots 133 extend through the bottom wall 11 and are respectively adjacent to the front and rear walls 14, 15. Each pair of slots 133 is opposite to each other and communicates with a corresponding through hole 13. A projecting portion 134 downwardly projects into each slot 133 from the top wall 10. A pair of U-shaped gaps 130 is longitudinally defined in the bottom wall 11. Each gap 130 has a middle portion communicating with a corresponding through hole 13. The gaps 130 extend through middle portions of corresponding side walls 16 and inwardly extend to each other. The through holes 13, slots 133 and gaps 130 cooperatively define a receiving space (not labeled) for receiving the contact terminals 2, the spring terminals 3 and retaining contacts 4. Therefore, cross sections of the receiving space adjacent to the bottom wall 11 are of generally cross-shape. Cross sections of the receiving space adjacent to the top wall 10 are of generally rectangular. A horizontal recess 131 is outwardly defined in a lower portion of an inner periphery of each gap 130. The recesses 131 communicate with corresponding slots 133 and through holes 13.

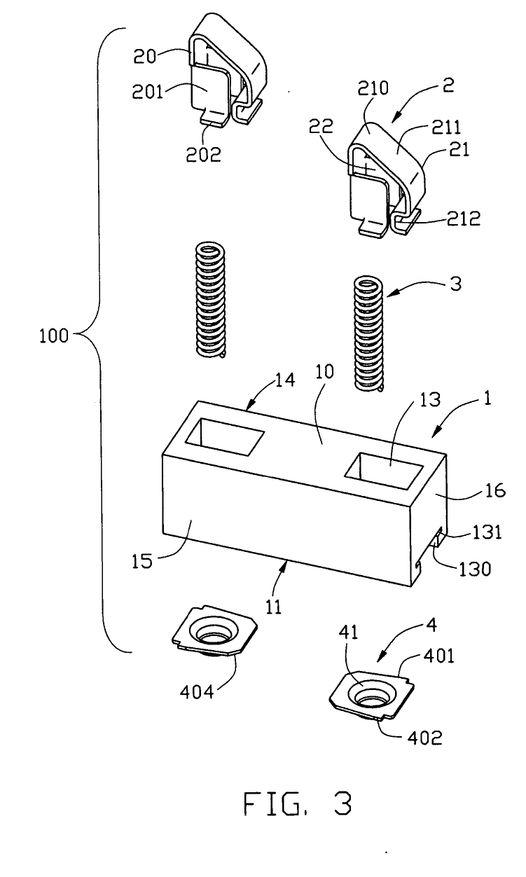

Referring to FIG. 3 in conjunction with FIG. 4, the contact terminals 2 are formed by stamping and are mounted in the insulative housing 1. Each contact terminal 2 includes a substantially rectangular body portion 20 and a cantilevered beam 21 downwardly and angularly extending from a top portion of the body portion 20, thereby having a substantially V-shaped configuration. The body portion 20 has a pair of wings 201 perpendicularly bending toward the cantilevered beam 21 from opposite side edges thereof. A receiving room 22 is defined by the body portion 20, the wings 201 and the cantilevered beam 21. Each wing 201 has a flange 202 outwardly and transversely extending from a bottom edge thereof. The contact terminal 2 has an upwardly projecting contact portion 210 on a top portion thereof for interconnecting the body portion 20 and the cantilevered beam 21. The cantilevered beam 21 comprises an outer leading face 211 extending downwardly and angularly from the contact portion 210. A mating electrical device (not shown) can slide upwardly along the lead face 211 to electrically connect with the contact portion 210. The cantilevered beam 21 further has an engaging portion 212 downwardly extending from a bottom end of the leading face 211. The engaging portion 212 is of a generally U-shaped configuration and projects inwardly to substantially abut against side edges of wings 201. Each contact terminal 2 has a generally quadrate lower mouth 213 defined by the body portion 20, the wings 201 and the engaging portion 212.

Each spring terminal 3 is received in the receiving room 22 of the contact terminal 2. The spring terminals 3 are coiled springs in the present invention and interconnect the contact terminals 2 and the retaining contacts 4. The outer diameter of each coiled spring is substantially corresponding to an inner periphery of a corresponding quadrate receiving cavity 213 of the contact terminal 2.

The retaining contact 4 is formed of a sheet metal and is fixed in the housing 1. The retaining contact 4 has a substantially dome-shaped portion (not labeled) downwardly stamped from a substantially central portion thereof. The dome-shaped portion comprises an upwardly exposed retaining cavity 41 for receiving the coiled spring 3. The dome-shaped portion forms a soldering nod 410 on a lower surface thereof for soldering to a printed circuit board (not shown). The soldering nod 410 protuberates beyond the retaining cavity 41 and the bottom wall 11 for facilitating soldering the retaining contact 4 to the printed circuit board. The retaining contact 4 has a horizontal extending fixing slice 401 surrounding a top portion of an outer periphery of dome-shaped portion for latching into the recesses 131 of the housing 1. Thickness of the fixing slice 401 is substantially equal to that of the recess 131 of the housing 1. The fixing slice 401 has a pair of protuberant barbs 402 outwardly projecting from a rear portion thereof for securely engaging with the recess 131 of the housing 1. The fixing slice 401 has a pair of angular guiding sections 404 cut from opposite sides of a front portion thereof for facilitating inserting the retaining contact 4 into the recess 131 of the housing 1.

Referring to FIGS. 1-4, in assembly, firstly, the contact terminals 2 are upwardly inserted into the housing 1 from a bottom of the through hole 13. The flanges 202 of the wings 201 of the contact terminals 2 are respectively inserted into the housing 1 along the slots 133 and abut against the projecting portions 134. The lead face 211 and contact portion 210 of the contact terminal 2 projects beyond the top wall 10 of the insulative housing 1. Secondly, an upper end of the coiled spring 3 is inserted into the receiving room 22 of the contact terminal 2 and is secured in the quadrate lower mouth 213 of the contact terminal 2. Finally, the retaining contacts 4 cover the gaps 130 of the bottom wall 11 of the housing 1 with the fixing slices 401 latching into the recesses 131. The retaining holes 41 engage with lower ends of the coiled springs 3. The soldering nod 410 of each retaining contact 4 is soldered to the printed circuit board so that the electrical connector 100 can electrically connect with the printed circuit board.

In use, if a mating electrical connector is horizontally pushed to contact with the lead face 211 of the contact terminal 2 and upwardly slides along the lead face 211. The lead face 211 is exerted a downward pressing force. As a result, the spring terminal 3 is compressed and the contact terminal 2 is downwardly pressed. The mating electrical connector (battery, SIM card etc. not shown) is leaded by the leading surface 211 of the contact terminal 2 and contacts with the contact portion 210 of the contact terminal 2. Alternatively, the mating electrical connector can press the contact portion 210 in a top-to-bottom direction, thereby electrically connecting with the electrical connector 100.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. An electrical connector adapted for mounting on a printed circuit board comprising:
an insulative housing comprising a top wall and a bottom wall and defining a receiving space through the top and bottom walls thereof;
a contact terminal retained in the receiving space of the housing and comprising a top contact portion projecting beyond the top wall of the housing and a leading face extending from the contact portion;
a retaining contact retained in the receiving space and projecting beyond the bottom wall of the housing; and
a spring terminal secured between the retaining contact and the contact terminal;

2. The electrical connector according to claim 1, wherein the contact terminal includes a body portion and a cantilevered beam, said contact portion interconnecting the body portion and the cantilevered beam, and wherein the cantilevered beam angularly and downwardly extending from the contact portion, the leading face being arranged on the cantilevered beam.

3. The electrical connector according to claim 2, wherein the body portion of said contact terminal comprises a pair of wings bending toward said cantilevered beam from opposite side edges thereof, and wherein the contact terminal has a receiving room defined by the body portion, the wings and said cantilevered beam.

4. The electrical connector according to claim 3, wherein said wings each has a flange outwardly and transversely bending from a bottom end thereof, and wherein the housing forms a pair of projecting portions projecting into the receiving space for engaging with the flanges.

5. The electrical connector according to claim 1, wherein said cantilevered beam has an engaging portion at bottom end thereof received in the received space of the housing, a quadrate receiving cavity being defined by the body portion, the wings and the engaging portion for securing with said spring terminal.

6. The electrical connector according to claim 5, wherein said spring terminal is a coiled spring.

7. The electrical connector according to claim 6, wherein said retaining contact has a retaining cavity at inner-surface thereof for receiving a lower end of the coiled spring.

8. The electrical connector according to claim 7, wherein the retaining contact has a retaining slice around the retaining cavity, and wherein said insulative housing has a recess horizontally defined in the bottom wall for engaging with a retaining slice of the retaining contact.

9. An electrical connector comprising:
an insulative housing defining at least one passageway extending through both upper and lower faces thereof;
at least one conductive terminal disposed in the said passageway;
stopper devices formed on the terminal and the passageway to prevent said terminal from excessively forwardly moving;
a retaining contact retained around the lower face of the housing; and
a biasing device located between the terminal and the retaining contact to urge the terminal to move upwardly until stopper devices functions while still allowing said terminal to move downwardly during mating.

10. The electrical connector as claimed in claim 9, wherein said terminal is inserted into the passageway from the lower face toward the upper face.

11. The electrical connector as claimed in claim 9, wherein said retaining contact is assembled to the housing in a direction parallel to the top face.

12. The electrical connector as claimed in claim 9, wherein said terminal is inserted into the passageway from the lower face toward the upper face in a first direction which is perpendicular to a second direction along which the retaining contact is assembled to the housing.

13. The electrical connector as claimed in claim 9, wherein a tip of said terminal extends upwardly above the upper face.

14. The electrical connector as claimed in claim 9, wherein the terminal defines a receiving room with the biasing device received therein.

15. A method of assembling an electrical connector, comprising steps of:
providing an insulative housing with at least one passageway extending through both upper and lower faces thereof;
inserting a terminal into the passageway from the lower face in a first direction;
loading a spring into the passageway with thereof one portion engaged with the terminal; and
assembling a retaining contact to the housing in a second direction perpendicular to said first direction; wherein
said spring is compressed between said terminal and said retaining contact so that the terminal is urged to move upwardly and then stop at a predetermined position while being allowed to move downwardly during mating and vibration.
